(19) United States
(12) Patent Application Publication
(10) Pub. No.: US 2001/0034584 A1
(43) Pub. Date: Oct. 25, 2001

(54) Circular feature Filter

(76) Inventors: Edison T. Hudson, Chapel Hill, NC (US); James McCormick, Barrington, RI (US)

Correspondence Address: David B. Ritchie, Thelen Reid & Priest LLP, P.O. Box 640640, San Jose, CA, 95164-0640, US

(21) Appl. No.: 09/779,007

(22) Filed: Feb. 7, 2001

Related U.S. Application Data
(60) Provisional application No. 60/188,581, filed on Mar. 10, 2000.

(51) Int. Cl. G01B 3/22

(52) U.S. Cl. 702/169; 702/155

(57) ABSTRACT

A method for recognizing circular features and determining the true centers of the circular features calculates a fitted circle that has a radius within a small range of the known radius of a known model. This method recognizes circular contact features on electronic components such as bumps on a flip chip and pads on a substrate and other visually similar applications and employs an algorithm which is unaffected by circular feature damage, artifact illuminations or traces connecting pads and contact bumps which create distortions that typically result in inaccuracies in determining the true center of the circular feature when using conventional center of mass or “centroid” algorithms. The method for filtering out the distortions includes determining the distance from the centroid of the circular contact feature to the boundary as a function of angle. Determining the boundary data in this manner creates a signature which provides a one dimensional representation of a two dimensional boundary. Once the signature is plotted the data can be passed through a low pass filter to reduce noise or small scale distortions. Acceptable bounds for the variation of the radius can be selected and all points along the boundary that do not fall within the selected bounds can be eliminated. The remaining points are used to fit a circle and compute a new centroid for the circular feature.

### RELATED APPLICATIONS

This application claims the benefit of provisional U.S. patent application Ser. No. 60/188581 filed on Mar. 10, 2000 in the names of Edison T. Hudson and James McCormick and commonly assigned herewith.

### FIELD OF THE INVENTION

The present invention is related to the alignment and registration of components onto substrates in a machine placement environment. More particularly, the present invention is directed to a method of locating the true center of circular contact features of components and substrates to facilitate a more accurate alignment and registration of components to substrate features.

### BACKGROUND OF THE INVENTION

Machine control systems are well known in the art. Such systems include, for example, systems for controlling robotic assembly equipment such as pick and place (or placement) machines. A placement machine is a robotic instrument for picking up electronic and similar parts from component feeders and placing them at their assigned locations on a printed circuit board (PCB). Once all parts are placed, the PCB is placed in a reflow oven and solder paste disposed on the PCB melts forming permanent electrical connections between pads on the PCB and electrical contacts, leads or “pins” on the electrical components.

An ideal bump or pad on a silicon die or electronic assembly should be circular. However, when the boundary of a circular feature such as a bump is computed it may be distorted by the presence of extra or non uniform solder, a circuit trace running to the bump or illumination artifacts such as specular reflections. In the case of traditional machine vision algorithms based on finding the center of mass, or “centroid” of the image, the center value calculated is skewed by the missing or extra data resulting from such distortion. Extra data includes the very common occurrence in circuit design of a trace leading away from the bump or pad feature. Trace features cause offset to the true center of the pad and so introduce a significant error in the center of the feature. These errors can lead to a net bias in determining the correct center for the circular bumps and pads and thus lead to inaccurate positioning of components for placement onto substrates in a placement machine application.

Accordingly, a need exists for a method of locating the true center of circular contact features such as bumps on flip chips or pads on substrates in order to facilitate more accurate alignment and registration of these components to these substrates.

### BRIEF DESCRIPTION OF THE INVENTION

A method for recognizing circular features and determining the true centers of the circular features calculates a fitted circle that has a radius within a small range of the known radius of a known model. This method recognizes circular contact features on electronic components such as bumps on a flip chip and pads on a substrate and other visually similar applications and employs an algorithm which is unaffected by circular feature damage, artifact illuminations or traces connecting pads and contact bumps which create distortions that typically result in inaccuracies in determining the true center of the circular feature when using conventional center of mass or “centroid” algorithms. The method for filtering out the distortions includes determining the distance from the centroid of the circular contact feature to the boundary as a function of angle. Determining the boundary data in this manner creates a signature which provides a one dimensional representation of a two dimensional boundary. Once the signature is plotted the data can be passed through a low pass filter to reduce noise or small scale distortions. Acceptable bounds for the variation of the radius can be selected and all points along the boundary that do not fall within the selected bounds can be eliminated. The remaining points are used to fit a circle and compute a new centroid for the circular feature.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a schematic diagram of a placement machine representing a characteristic application for a method in accordance with a specific embodiment of the present invention.

FIG. 2 is a diagram of a hypothetical digital image of a nominal circular bump or pad as would be used in generating a model circular feature signature in a method in accordance with a specific embodiment of the present invention.

FIG. 3 is a diagram of a hypothetical digital image of a distorted bump or pad demonstrating a circular feature with an excessive perimeter as would be used in generating a circular feature signature in a method in accordance with a specific embodiment of the present invention.

FIG. 4 is a diagram of a hypothetical digital image of a bump or pad with a trace running away from it as would be used in generating a circular feature signature in a method in accordance with a specific embodiment of the present invention.

FIG. 5 is a diagram of a hypothetical digital image of a bump or pad demonstrating a circular feature with a partial perimeter as would be used in generating a circular feature signature in a method in accordance with a specific embodiment of the present invention.

FIG. 6 is a plot illustrating radius (vertical axis) versus angle (horizontal axis) of the edge of the circular feature from its centroid “signature plots” generated in accordance with the present invention using the hypothetical digital images of the circular bumps or pads represented by FIGS. 2 through 4 in accordance with a specific embodiment of the present invention.

FIG. 7 is a diagram illustrating examples of the maximum and minimum acceptable bounds for the variations in radius generated by the method using digital images of circular bumps or pads in accordance with a specific embodiment of the present invention.

### DETAILED DESCRIPTION

Embodiments of the present invention are described herein in the context of a circular feature filter. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

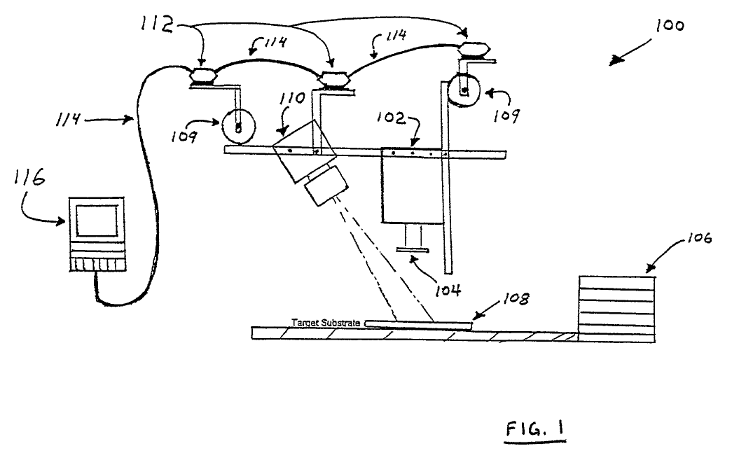

The present invention is represented in a specific embodiment by an algorithm which performs filtering and circle fitting functions most typically in a placement machine application as is illustrated in FIG. 1. However, the method of the present invention is not limited to such an application and can be used on any computer, application specific integrated circuit and the like. The placement machine 100 of FIG. 1 has a pick-up head 102 transportable in X, Y, Z and T (rotational) directions which picks up components 104 (with a vacuum pick-up, gripper pick-up, or similar device) from component feeders 106 and transports them for placement onto a target substrate 108 such as a PCB. The components 104 in accordance with this example are typically electrical, electromechanical or electro-optic components and require highly accurate placement onto the target substrate 108 due to typically densely packed input/output (I/O) connections. Placement machine 100 generally has an imaging system 110 of some kind which observes the components 104 and the target substrate 108 in order to measure, register and align under-side contact and edge features of the components to corresponding target substrate features in order to achieve accurate placement. Placement machine 100 usually includes a number of motion control devices 112 for driving motors (also referred to as actuators) and sending and receiving digital and analog data. In addition, peripherals of placement machine 100 such as the imaging system 110, camera lighting (not shown), pick-up head 102 and vacuum generators (for use with vacuum pick-ups) may be wired to specific data input/output lines on the motion control devices 112.

The method of the present invention applied to the real-time processing of digital images captured by the imaging system 110 provides an accurate recognition of circular contact features such as the bumps on a flip chip and pads on a substrate despite circular feature damage, artifact illuminations or traces connecting pads and contact bumps which create digital image distortions of the circular features. Accurate recognition of the circular contact features permits the determination of their true centers. Therefore, calculations of the coordinate locations for component 104 and target substrate 108 circular contact features are more precise, resulting in better motion control of the pickup head 102 and a higher accuracy in registration and alignment between the component 104 and the target substrate 108.

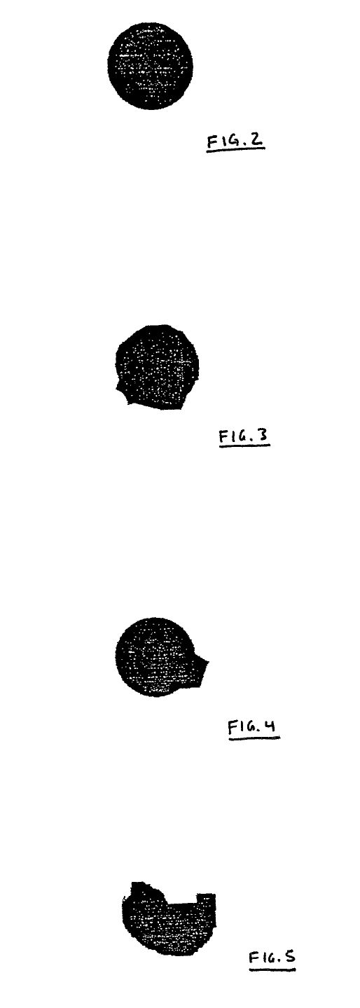

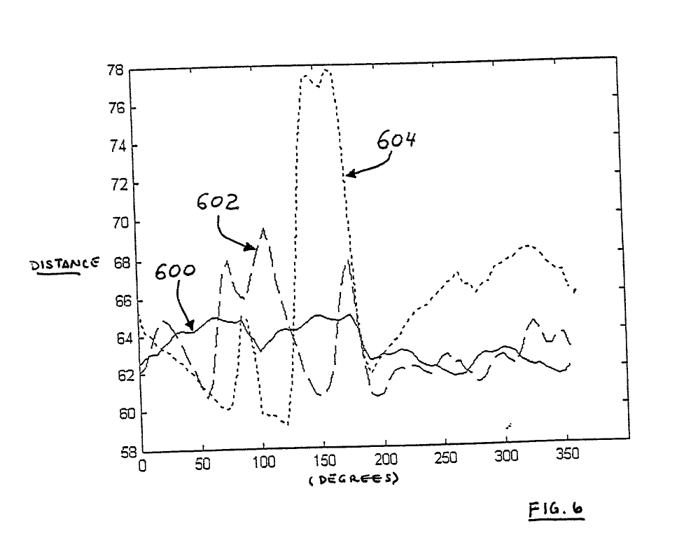

The method of the present invention can best be described with reference to hypothetical circular bumps or pads as might be digitally imaged by the described placement machine 100 of FIG. 1. A nominal circular bump or pad is hypothetically represented by the illustration in FIG. 2. A hypothetically distorted bump or pad simulating excess solder on one of it sides is illustrated in FIG. 3 and demonstrates a circular feature with an excessive perimeter. A bump or pad with a trace running away from it is illustrated in FIG. 4, and a partial bump or pad is illustrated in FIG. 5 demonstrating a circular feature with a partial perimeter.

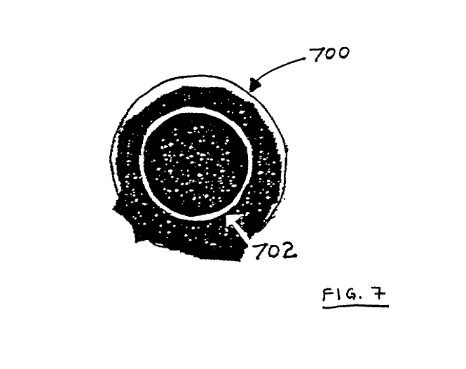

After receiving the digital image of the circular bump or pad as illustrated in FIGS. 2-5, the method determines the distance from the centroid to the boundary (i.e. the radius) as a function of angle. An example would be to determine the radius of the circular feature every five degrees (at least three points along the circle are required). Those of ordinary skill in the art will now realize that other angular resolutions may be used with the trade-off being that finer angular resolutions provide higher precision at the cost of additional computational load. Plotting the boundary data in this manner creates what is referred to herein as a “signature”. The signature provides a one dimensional representation of a two dimensional boundary. Each of the hypothetical circular bumps or pads of FIGS. 2-4 have been plotted in this manner and are represented by the radius versus angle plots as illustrated in FIG. 6. The solid line 600 of FIG. 6 represents the plot for the nominal bump digital image of FIG. 2. The long dashed line 602 of FIG. 6 represents the plot for the distorted bump digital image of FIG. 3. The small dashed line 604 of FIG. 6 represents the plot for the digital image of the bump or pad with a trace running away from it as illustrated in FIG. 4. As is clear from the plots in FIG. 6, this approach easily distinguishes which areas of the boundary for the circular bumps or pads are distorted.

Once the radial data is determined, the data is applied to a conventional low pass filter to reduce noise and small scale distortions. Acceptable bounds for the variation of the radius from the centroid (i.e., permissible radii exist within a range defined by an upper bound and a lower bound, the radii being defined as centroid to detected edge feature) are set and all the perimeter points on the boundary that do not fall within the selected bounds are eliminated. An example of a maximum and minimum acceptable bound for the variation in radius is illustrated in FIG. 7. A maximum perimeter 700 and minimum perimeter 702 define the limits within which radial perimeter data points will be accepted and not eliminated. The remaining points are used to fit a circle using, for example, the well-know least squares fit or any other suitable method, and an “adjusted centroid” is calculated from this new circle, the adjusted centroid defining the center of the “real” feature corrected for defects, distortions and optical effects.

The method of the present invention is thus capable of calculating fitted circles for digital images of circular bumps or pads that have a radius that is within a small range of the known radius of a nominal model, even when part of the perimeter edge is missing or obscured as indicated in FIGS. 2-5. The true center of the bump feature is calculated in the absence of complete data. The method of the present invention is not affected by circular feature damage, artifact illuminations or by traces connecting pads or bumps and returns a true center for each pad or bump feature, thus improving accuracy of the position calculations of the component and substrate.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for determining the location of an adjusted centroid of a circular feature, said method comprising:
obtaining an image of the circular feature;
determining a location of a centroid of said circular feature;
measuring at a plurality of at least three angular locations about said centroid a distance between said centroid and an edge of said circular feature to create a data set;
establishing minimum and maximum acceptable measured distances between said centroid and said edge;
eliminating elements of said data set not within a range defined by said minimum and maximum acceptable measured distances;
fitting a circle to remaining elements in said data set; and
calculating a location of an adjusted centroid for said fitted circle.

2. A method in accordance with claim 1, further comprising:
applying a low pass filter to said data set.

3. An apparatus for determining the location of an adjusted centroid of a circular feature, said apparatus comprising:
means for obtaining an image of the circular feature;
means for determining a location of a centroid of said circular feature;
means for measuring at a plurality of at least three angular locations about said centroid a distance between said centroid and an edge of said circular feature to create a data set;
means for establishing minimum and maximum acceptable measured distances between said centroid and said edge;
means for eliminating elements of said data set not within a range defined by said minimum and maximum acceptable measured distances;
means for fitting a circle to remaining elements in said data set; and
means for calculating a location of an adjusted centroid for said fitted circle.

4. An apparatus in accordance with claim 3, further comprising:
means for applying a low pass filter to said data set.

5. A program storage device containing a program of instructions readable by a machine for performing a method for determining the location of an adjusted centroid of a circular feature, said method comprising:
obtaining an image of the circular feature;
determining a location of a centroid of said circular feature;
measuring at a plurality of at least three angular locations about said centroid a distance between said centroid and an edge of said circular feature to create a data set;
establishing minimum and maximum acceptable measured distances between said centroid and said edge;
eliminating elements of said data set not within a range defined by said minimum and maximum acceptable measured distances;
fitting a circle to remaining elements in said data set; and
calculating a location of an adjusted centroid for said fitted circle.

6. A device in accordance with claim 5, wherein said method further comprises:
applying a low pass filter to said data set.
